(19) United States
(12) Patent Application Publication
(10) Pub. No.: US 2023/0394047 A1
(43) Pub. Date: Dec. 7, 2023

(54) CLIENT-SIDE RANKING OF SOCIAL MEDIA FEED CONTENT

(71) Applicant: Meta Platforms, Inc., Menlo Park, CA (US)

(72) Inventors: Kyongtai Alex Min, Jersey City, NJ (US); Michael David Plumpe, Seattle, WA (US); Eryk Helenowski, Barrington, IL (US)

(21) Appl. No.: 17/515,329

(22) Filed: Oct. 29, 2021

(51) Int. Cl. G06F 16/2457; G06F 16/9538; G06F 16/9536

(52) U.S. Cl. CPC G06F 16/24578; G06F 16/9538; G06F 16/9536

(57) ABSTRACT

Methods, systems, and storage media for searching for client-side ranking of feed content are disclosed. Exemplary implementations may: determine, through communication with a server, a current state of a local ranking algorithm; receive, at a client executing on a device of the user, an intermediate representation of code; execute the intermediate representation of code on the client to update the local ranking algorithm; determine a ranking of feed content for the user based at least in part on the local ranking algorithm; and cause display of feed content on the device of the user, the feed content displayed according to the ranking.

### TECHNICAL FIELD

The present disclosure generally relates to providing social media feeds and more particularly to client-side ranking of social media feed content.

### BACKGROUND

One of the primary features of many social networking platforms, and other applications focusing on content delivery is the idea of a content feed. Posts, articles, photos, videos, and/or other digital content are served to the user, generally based on some algorithm. Conventionally, this algorithm is designed to feed content to the user based on their prior history of consuming and/or reacting to other content such that the user is provided with content that they likely want to see. These algorithms can be complex and are thus maintained on network servers where processing power and data storage can be leveraged beneficially. When user data is needed, it must be transmitted to network servers to be stored and processed. Ranking data is then delivered to the user's device to provide content which may be organized and/or filtered in a manner to enhance the user's experience.

### BRIEF SUMMARY

The subject disclosure provides for systems and methods for providing social media feeds. According to various aspects, ranking of social media feed content can be done with a bifurcated process. For example, a ranking algorithm may exist on a network connected server to provide feed ranking data based on various data that it is provided about the user, the content and other variables. A local ranking algorithm located on a user's device can provide feed ranking data to adjust or supplement the ranking feed data from the server, allowing certain algorithm input data to avoid being sent to the network connected server.

One aspect of the present disclosure relates to a method for client-side ranking of feed content. The method may include determining, through communication with a server, a current state of a local ranking algorithm. The method may include receiving, at a client executing on a device of the user, an intermediate representation of code. The intermediate representation of code may be generated based at least in part on the current state of the local ranking algorithm. The method may include executing the intermediate representation of code on the client to update the local ranking algorithm. The method may include providing local data to the local ranking algorithm. The method may include determining a ranking of feed content for the user for the user based at least in part on the local ranking algorithm processing of the local data. The method may include causing display of feed content on the device of the user, the feed content displayed according to the ranking.

Another aspect of the present disclosure relates to a system configured for client-side ranking of feed content. The system may include one or more hardware processors configured by machine-readable instructions. The processor(s) may be configured to determine, through communication with a server, a current state of a local ranking algorithm. The processor(s) may be configured to receive, at a client executing on a device of the user, an intermediate representation of code. The intermediate representation of code may be generated based at least in part on the current state of the local ranking algorithm. The processor(s) may be configured to execute the intermediate representation of code on the client to update the local ranking algorithm. The processor(s) may be configured to receive, at the client, preliminary ranking data from the server. The processor(s) may be configured to obtain, at the client, local data to provide to the local ranking algorithm. The processor(s) may be configured to by the local ranking algorithm, a ranking of feed content for the user based at least in part on the local data and the preliminary ranking data. The processor(s) may be configured to cause display of feed content on the device of the user, the feed content displayed according to the ranking.

Yet another aspect of the present disclosure relates to a non-transient computer-readable storage medium having instructions embodied thereon, the instructions being executable by one or more processors to perform a computer-implemented method for client-side ranking of feed content. The method may include determining, through communication with a server, a current state of a local ranking algorithm. The method may include receiving, at a client executing on a device of the user, an intermediate representation of code. The intermediate representation of code may be generated based at least in part on the current state of the local ranking algorithm. The method may include executing the intermediate representation of code on the client to update the local ranking algorithm. The method may include determining a ranking of feed content for the user based at least in part on the local ranking algorithm. The method may include causing display of feed content on the device of the user, the feed content displayed according to the ranking.

Still another aspect of the present disclosure relates to a system configured client-side ranking of feed content. The system may include means for determining, through communication with a server, a current state of a local ranking algorithm. The system may include means for receiving, at a client executing on a device of the user, an intermediate representation of code. The intermediate representation of code may be generated based at least in part on the current state of the local ranking algorithm. The system may include means for executing the intermediate representation of code on the client to update the local ranking algorithm. The system may include means for determining a ranking of feed content for the user based at least in part on the local ranking algorithm. The system may include means for causing display of feed content on the device of the user, the feed content displayed according to the ranking.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system architecture configured for client-side optimized content feed ranking, according to certain aspects of the disclosure.

FIG. 2 illustrates an example client-side flow diagram, according to certain aspects of the disclosure.

FIG. 3 illustrates an example server-side flow diagram, according to certain aspects of the disclosure.

FIG. 4 illustrates a system configured for providing social media feeds, in accordance with one or more implementations.

FIG. 5 illustrates an example flow diagram for providing social media feeds, according to certain aspects of the disclosure.

FIG. 6 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Social media feed ranking and/or ordering typically requires communication with a model or algorithm residing on a remote server. Some data communication to and from the server in this way may be prohibitively slow due to their real-time nature. In other cases, communication of certain data types from of the user device may be restricted due to privacy concerns. These speed and privacy restrictions may lead to a sub-optimal experience for the user.

The subject disclosure provides for systems and methods for providing social media feeds. By implementing at least a portion of the social media feed ranking on a user's device, the system can avoid sending certain user, environmental and other related data to network servers for processing. This can result in greater application responsiveness (speed) for the user, as well as help alleviate privacy concerns associated with communicating and storing certain types of data.

Implementations described herein address the aforementioned shortcomings and other shortcomings by allowing social media feed ranking and/or ordering algorithms to be at least partially implemented locally on a user's device. These models and/or algorithms may be communicated from a networked server to the user's device to allow for near-real-time processing of certain user interaction, session, and/or environmental data without the privacy concerns of off-device transmission.

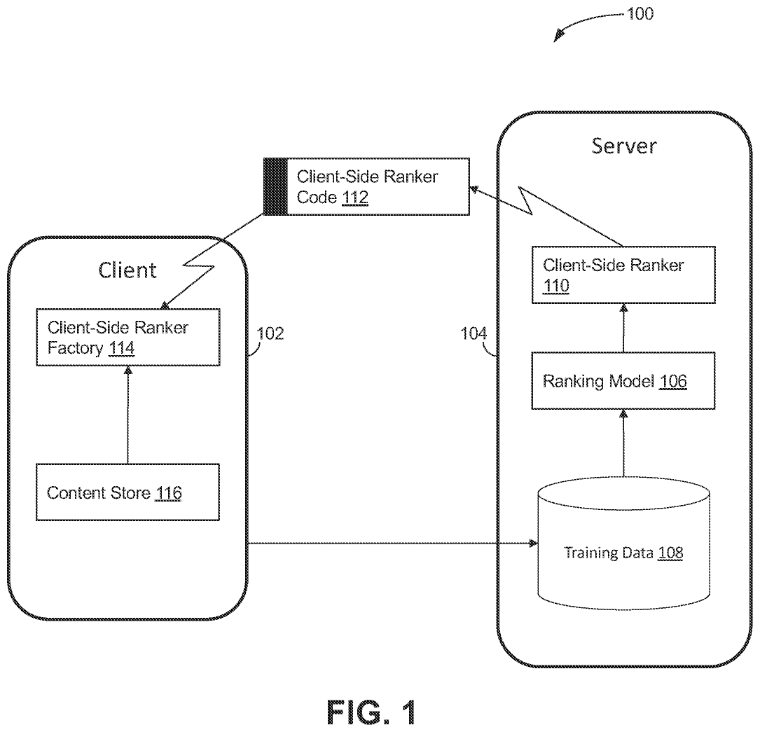

FIG. 1 illustrates a system 100 configured for client-side optimized content feed ranking, according to certain aspects of the disclosure. In some implementations, system 100 may include a client device 102 capable of communicating with a server 104. The server 104 includes a ranking model 106 connected to a training data database 108. The server 104 also includes a client-side ranker module 110 which is used to communicate client-side ranker code 112 to the client device 102. On the client device 102, a client-side ranker factory 114 processes the client-side ranker code 112 to implement/update a local ranking algorithm. The local ranking algorithm from the client-side ranker factory 114 applies a ranking to content in a content store 116 on the client device 102.

According to various embodiments, training data may be provided to the server 104 and stored in the training data database 108. The training data may be provided from the client device 102, and may include data regarding the user's interaction with content on the client device. The training data may also include data from other sources, including without limitation, content interaction data for other users, aggregated content interaction data, environmental data, and general client device data.

Using the connection to the training data database 108, a ranking model 106 may generate an algorithm used to rank content feeds for one or more users. A content feed can include, for example, a list or stream of media delivered to a user for viewing, sharing, commenting upon, reacting to or other interaction. Examples include feeds of photos and videos, collections of photos and/or videos, stories, and reels. At any given time, a group of this digital media in a content feed may be available for a user to view. A ranking can be used to determine what digital media in the content feed should be displayed for the user at a given time and in what order. The ranking model 106 may include or operate in communication with a client side ranker module 110. The client side ranker module 110 manages a local ranking algorithm which can be leveraged on the client device 102 using locally-provided data. In this way, any data from the ranking module 106 may be supplemented by additional ranking or ranking refinement from the local ranking algorithm based on data acquired at a given time on the client device.

A communication from the client-side ranker factory 114 on the client device 102 to the client-side ranker 110 on the server 104 is used to determine the status of the ranking algorithm on the client device 102. If the status indicates that an update is needed, client-side ranker code 112 is communicated from the client-side ranker 110 to the client-side ranker factory 114. The client-side ranker code 112 may be executable code to install or update a ranking algorithm. In other embodiments, the client-side ranker code 112 may be an intermediate representation of code which when processed may be executable to install or update a ranking algorithm. The intermediate representation of code may include the use of encryption, compression, and/or other intermediate code representations like bytecode, portable code or other code designed for execution by an interpreter at the client-side ranker factory 114. The intermediate representation of code can be used to make the client-side ranker code 112 faster, easier, or more secure to transmit from the server 104 to the client device 102.

On the client device 102, client-side ranker factory 114 executes the client-side ranker code 112 to generate or update a local ranking algorithm. The ranking algorithm may receive local data to create and adjust the ranking or order of content being displayed (or to be displayed) on the client device 102 to a user. The local ranking algorithm may additionally receive ranking input from the ranking model 106 (by way of communication with the server 104). Local data can include, for example and without limitation, real-time or recent user interaction data, environmental data, and social graph or connection data. The user interaction data can include information about the various ways that a user may be interacting with content, with applications, and with the client device 102. Environmental data can include data about the state of the client device 102, or generally the area proximate to the client device 102 and the user. Social graph and connection data includes data surrounding the user's connections or related users within the social media platform. Any of the local data may be delivered in real-time (including near-real-time) to the ranking algorithm in order to adjust a content feed ranking in a more expedient manner than if the data were to be transmitted first to the server 104 to be processed.

The ranking algorithm may make use of the local data in a number of ways to make on-the-fly adjustments to the content being delivered to a user. By way of example, user data including information about the categories of content being viewed may be used to rank higher similar content in those categories. A user viewing and interacting with content related to sports may cause the ranking algorithm to adjust the ranking of content to be delivered to the user to promote similar sports-related content. As another example, environmental data including information about the user's device battery state may be used to rank lower content which would be more energy intensive to view. When the ranking algorithm receives data indicating a low battery level, it may adjust the ranking of video content compared to other static content to prolong battery life and allow the user to use the application for a longer period of time.

The client device 102 may include a content store 116 where feed content is stored or cached, ready to be displayed to the user. The content store may be constantly or periodically updated with additional content from a content server (which may or may not be the same server 104 maintaining the training data 108 and/or ranking module 106). The content in the content store 116 is displayed to the user in an order based on the results from the local ranking algorithm.

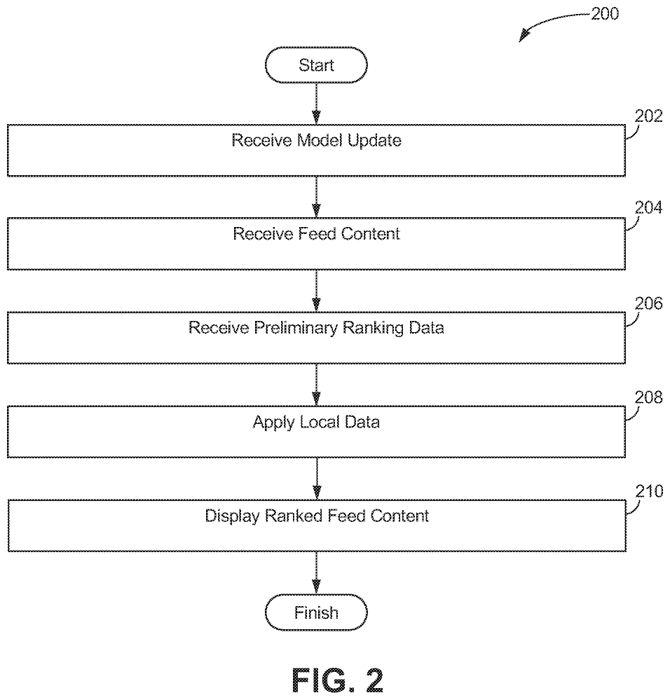

FIG. 2 illustrates an example client-side flow diagram (e.g., process 200) for providing social media feeds, according to certain aspects of the disclosure. Further for explanatory purposes, the steps of the example process 200 are described herein as occurring in serial, or linearly. However, multiple instances of the example process 200 may occur in parallel.

At step 202, the process 200 may include receiving a model update at an application running on a client device, from a server. The model update may include instructions, code or an intermediate representation of code to be processed on the client device. This model update is used to update a local ranking model for the application running on the client device. This in turn provides an improved ranking of a content feed of digital media to be displayed to the user.

At step 204, the application will receive digital media for the content feed. This content is to be delivered to the user during interaction with the application. This step can happen before, after or concurrently with the previous step 202. In this way, there may be a cache of digital media on the client device which is periodically updated.

At step 206, preliminary ranking data may be received by the application, according to various examples. This preliminary ranking data may include rankings for the digital media to be displayed, based on a ranking model residing on a network connected server.

To supplement any preliminary ranking data, at step 208, local data is input to the local ranking model to provide updated rankings of the digital media to be displayed. This local data may be accompanied by the preliminary ranking data to allow the local ranking model to generate the updated ranking.

With the updated ranking data, at step 210, the ranked digital media is displayed in the content feed. As the user interacts with the application and the content feed, user data may be collected and re-applied to the local ranking model, repeating step 208, to continually update and re-rank the content feed of digital media.

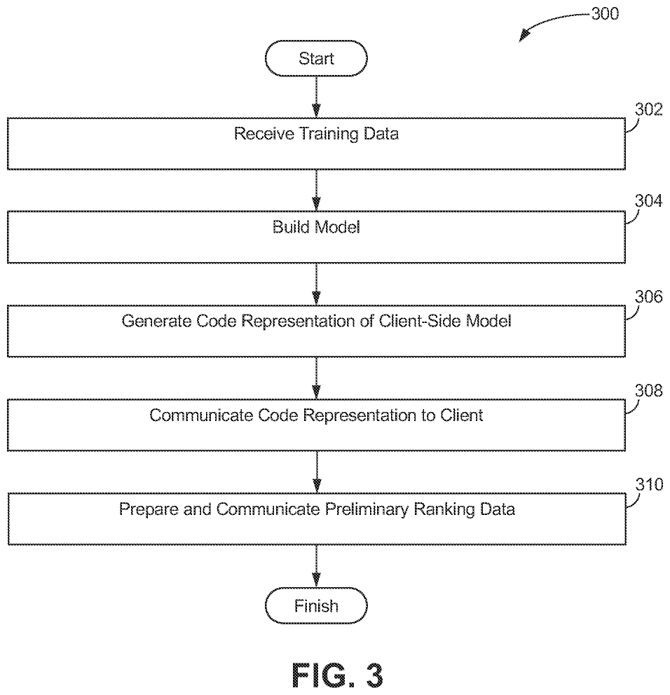

FIG. 3 illustrates an example server-side flow diagram (e.g., process 300) for providing social media feeds, according to certain aspects of the disclosure. Further for explanatory purposes, the steps of the example process 300 are described herein as occurring in serial, or linearly. However, multiple instances of the example process 300 may occur in parallel.

At step 302, the process 300 may include receiving, at a server, training data regarding user interaction with digital media content. This training data may include various information about digital media alongside indicators of user experience (for example, likes, views, view time, comments, shares . . . ). Using the training data, at step 304, a model is built for the purpose of providing rankings for feeds of digital content. In some examples, this model may include a server side-algorithm and a client-side algorithm. The client-side algorithm may be stored on the server for communication to a client device.

At step 306, the code for the client-side algorithm is prepared for communication to the client device. In some examples, an intermediate representation of the code is generated to facilitate this communication. The client-side algorithm source code may be compiled into an object code or portable code instructions set prior to communication to the client device. Once prepared, the intermediate representation of code is communicated to the client device at step 308. Receipt of this code allows the client device to interpret and execute the client side algorithm. This communication may occur periodically or may be triggered by a request from the client device. A client device may communicate with the server to determine the status of the client-side algorithm and whether an update is required.

At step 310, according to various embodiments, the server may process, through the server-side algorithm, digital media being communicated to the client device. The result of this processing can include preliminary ranking data related to the digital media. This preliminary ranking data may be communicated to the client device to supplement the client-side algorithm ranking, or to be used as additional input data for the client-side ranking algorithm.

The disclosed system(s) address a problem in traditional social media feed provisioning techniques tied to computer technology, namely, the technical problems of the increased latency associated with server-based digital media content feed ranking, along with the potential privacy concerns surrounding communicating certain local and user data over a network. The disclosed system solves these technical problems by providing a solution also rooted in computer technology, namely, by providing for client-side ranking of social media feed content. The disclosed subject technology further provides improvements to the functioning of the computer itself because it improves processing and efficiency in providing social media feeds.

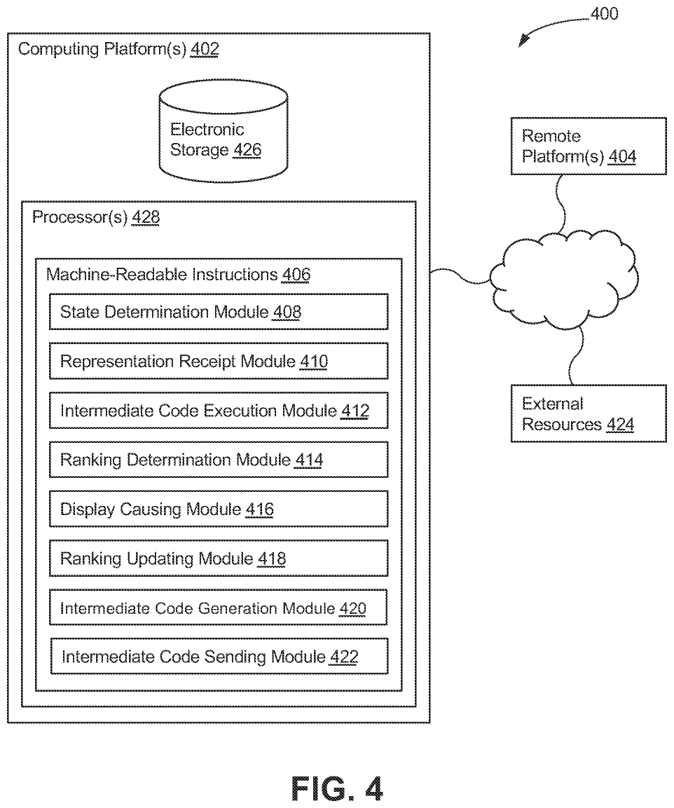

FIG. 4 illustrates a system 400 configured for providing social media feeds, according to certain aspects of the disclosure. In some implementations, system 400 may include one or more computing platforms 402. Computing platform(s) 402 may be configured to communicate with one or more remote platforms 404 according to a client/server architecture, a peer-to-peer architecture, and/or other architectures. Remote platform(s) 404 may be configured to communicate with other remote platforms via computing platform(s) 402 and/or according to a client/server architecture, a peer-to-peer architecture, and/or other architectures. Users may access system 400 via remote platform(s) 404.

Computing platform(s) 402 may be configured by machine-readable instructions 406. Machine-readable instructions 406 may include one or more instruction modules. The instruction modules may include computer program modules. The instruction modules may include one or more of state determination module 408, representation receipt module 410, intermediate code execution module 412, ranking determination module 414, display causing module 416, ranking updating module 418, intermediate code generation module 420, intermediate code sending module 422, and/or other instruction modules.

State determination module 408 may be configured to determine, through communication with a server, a current state of a local ranking algorithm. The local ranking algorithm may be provided with local data. In some cases, the local data may not be communicated to the server. By way of non-limiting example, the local data may include at least one of content likes, content shares, comments, messaging, dwell time, and location data. The local ranking algorithm may include weighting to be applied to types of the local data to control the influence of certain data on the ranking output. The local ranking algorithm may include a machine learning (ML) model. By way of non-limiting example, the local ranking algorithm may generate rankings based on at least one of environmental data, social graph data, or user interaction data. By way of non-limiting example, the user interaction data may include data regarding at least one of whether the user interacts media, type of user interaction with media, or dwell time on media. By way of non-limiting example, the environmental data may include data regarding at least one of quality of network connection, battery life, location data, inertial sensor data, or date and time data.

Representation receipt module 410 may be configured to receive, at a client executing on a device of the user, an intermediate representation of code. The intermediate representation of code may be generated based at least in part on the current state of the local ranking algorithm. The intermediate representation of code may be downloaded to the client. The client may include a virtual machine, interpreter or the like for processing the intermediate representation of code. The intermediate representation of code may be received by the client via a client-side ranker, and be used to update such ranker. The intermediate representation of code may include byte code, portable code or other object code including instructions for execution on the client device. The intermediate representation of code may include a string of bits. The intermediate representation of code may include a packaged file containing data to update at least a portion of the local ranking algorithm.

Intermediate code execution module 412 may be configured to interpret and execute the intermediate representation of code on the client to update the local ranking algorithm. The intermediate representation of code may be executable only on the client. Executing the intermediate representation of code may include interpreting, processing, decompiling or unpacking the file to update at least a portion of the local ranking algorithm.

Ranking determination module 414 may be configured to determine a ranking of feed content for the user based at least in part on the local ranking algorithm. The feed content may include media shared through a social media platform. A local ranking algorithm reference may be updated at a server. A network ranking algorithm at the server may be provided to generate preliminary ranking data. Preliminary ranking data may be received at the client, from the server. The preliminary ranking data may be provided to the local ranking algorithm. The preliminary ranking data may be stored or cached at the client. Determining the ranking of feed content for the user may be based at least in part on the preliminary ranking data and the output of the local ranking algorithm. The ranking of feed content for the user may be updated based at least in part on the local ranking algorithm and any received, stored or cached preliminary ranking data.

Display causing module 416 may be configured to cause display of feed content on the device of the user, the feed content is displayed according to the ranking ultimately guided by the local ranking algorithm.

Ranking updating module 418 may be configured to update the ranking of feed content based on updated user interactions.

Ranking updating module 418 may be configured to update updating the ranking of feed content based on updated data (e.g. user interaction, environmental, social graph/connection data).

Intermediate code generation module 420 may be configured to generate, at the server, the intermediate representation of code based at least in part on the current state of the ranking algorithm. The intermediate code generation module 420 may generate the intermediate representation of code periodically when the model on the server is updated, or when an update is requested from a client.

Intermediate code sending module 422 may be configured to send the intermediate representation of code to the client executing on the device of the user. The intermediate representation of code is not sent to the client executing on the device of the user if the local ranking algorithm reference is not different from the current state of the local ranking algorithm.

Display causing module 416 may be configured to cause display, at the client, of feed content based at least in part on executing the intermediate representation of code to update the local ranking algorithm to determine a ranking of the feed content.

In some implementations, computing platform(s) 402, remote platform(s) 404, and/or external resources 424 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 402, remote platform(s) 404, and/or external resources 424 may be operatively linked via some other communication media.

A given remote platform 404 may include one or more processors configured to execute computer program modules. The computer program modules may be configured to enable an expert or user associated with the given remote platform 404 to interface with system 400 and/or external resources 424, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms.

External resources 424 may include sources of information outside of system 400, external entities participating with system 400, and/or other resources. In some implementations, some or all of the functionality attributed herein to external resources 424 may be provided by resources included in system 400.

Computing platform(s) 402 may include electronic storage 426, one or more processors 428, and/or other components. Computing platform(s) 402 may include communication lines, or ports to enable the exchange of information with a network and/or other computing platforms. Illustration of computing platform(s) 402 in FIG. 4 is not intended to be limiting. Computing platform(s) 402 may include a plurality of hardware, software, and/or firmware components operating together to provide the functionality attributed herein to computing platform(s) 402. For example, computing platform(s) 402 may be implemented by a cloud of computing platforms operating together as computing platform(s) 402.

Electronic storage 426 may comprise non-transitory storage media that electronically stores information. The electronic storage media of electronic storage 426 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 426 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 426 may include one or more virtual storage resources (e.g., cloud storage, a virtual private network, and/or other virtual storage resources). Electronic storage 426 may store software algorithms, information determined by processor(s) 428, information received from computing platform(s) 402, information received from remote platform(s) 404, and/or other information that enables computing platform(s) 402 to function as described herein.

Processor(s) 428 may be configured to provide information processing capabilities in computing platform(s) 402. As such, processor(s) 428 may include one or more of a digital processor, an analog processor, a digital circuit designed to process information, an analog circuit designed to process information, a state machine, and/or other mechanisms for electronically processing information. Although processor(s) 428 is shown in FIG. 4 as a single entity, this is for illustrative purposes only. In some implementations, processor(s) 428 may include a plurality of processing units. These processing units may be physically located within the same device, or processor(s) 428 may represent processing functionality of a plurality of devices operating in coordination. Processor(s) 428 may be configured to execute modules 408, 410, 412, 414, 416, 418, 420, and/or 422, and/or other modules. Processor(s) 428 may be configured to execute modules 408, 410, 412, 414, 416, 418, 420, and/or 422, and/or other modules by software; hardware; firmware; some combination of software, hardware, and/or firmware; and/or other mechanisms for configuring processing capabilities on processor(s) 428. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, 416, 418, 420, and/or 422 are illustrated in FIG. 4 as being implemented within a single processing unit, in implementations in which processor(s) 428 includes multiple processing units, one or more of modules 408, 410, 412, 414, 416, 418, 420, and/or 422 may be implemented remotely from the other modules. The description of the functionality provided by the different modules 408, 410, 412, 414, 416, 418, 420, and/or 422 described below is for illustrative purposes, and is not intended to be limiting, as any of modules 408, 410, 412, 414, 416, 418, 420, and/or 422 may provide more or less functionality than is described. For example, one or more of modules 408, 410, 412, 414, 416, 418, 420, and/or 422 may be eliminated, and some or all of its functionality may be provided by other ones of modules 408, 410, 412, 414, 416, 418, 420, and/or 422. As another example, processor(s) 428 may be configured to execute one or more additional modules that may perform some or all of the functionality attributed below to one of modules 408, 410, 412, 414, 416, 418, 420, and/or 422.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In particular embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

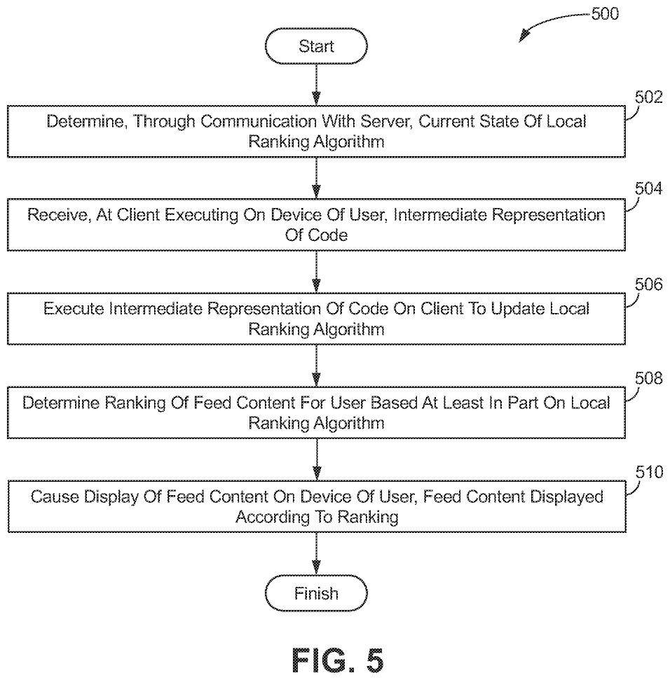

FIG. 5 illustrates an example flow diagram (e.g., process 500) for providing social media feeds, according to certain aspects of the disclosure. For explanatory purposes, the example process 500 is described herein with reference to FIGS. 1-4. Further for explanatory purposes, the steps of the example process 500 are described herein as occurring in serial, or linearly. However, multiple instances of the example process 500 may occur in parallel. For purposes of explanation of the subject technology, the process 500 will be discussed in reference to FIGS. 1-4.

At step 502, the process 500 may include determining, through communication with a server, a current state of a local ranking algorithm. At step 504, the process 500 may include receiving, at a client executing on a device of the user, an intermediate representation of code. The intermediate representation of code may be generated based at least in part on the current state of the local ranking algorithm. At step 506, the process 500 may include executing the intermediate representation of code on the client to update the local ranking algorithm. At step 508, the process 500 may include determining a ranking of feed content for the user based at least in part on the local ranking algorithm. At step 510, the process 500 may include causing display of feed content on the device of the user, the feed content displayed according to the ranking.

For example, as described above in relation to FIGS. 1-4, at step 502, the process 500 may include determining, through communication with a server, a current state of a local ranking algorithm, through state determination module 408. At step 504, the process 500 may include receiving, at a client executing on a device of the user, an intermediate representation of code, through representation receipt module 410. The intermediate representation of code may be generated based at least in part on the current state of the local ranking algorithm. At step 506, the process 500 may include executing the intermediate representation of code on the client to update the local ranking algorithm, through intermediate code execution module 412. At step 508, the process 500 may include determining a ranking of feed content for the user based at least in part on the local ranking algorithm, through ranking determination module 414. At step 510, the process 500 may include causing display of feed content on the device of the user, the feed content displayed according to the ranking, through display causing module 416.

According to an aspect, the local ranking algorithm comprises a machine learning (ML) model.

According to an aspect, the local ranking algorithm generates rankings based on at least one of environmental data, social graph data, or user interaction data.

According to an aspect, the user interaction data comprises data regarding at least one of: a) whether the user interacts media, b) the type of user interaction with media, or c) dwell time on media—how long the user stays viewing a media item before moving to the next or exiting. Other types of user interaction data is contemplated based on user navigation and experience with content and software on the client.

According to an aspect, the environmental data comprises data regarding at least one of quality of network connection, battery life, location data, inertial sensor data, date and time data, and other data associated with the state, location, proximity or condition of the client device.

According to an aspect, the process 500 further includes updating the ranking of feed content based on updated user interactions.

According to an aspect, the process 500 further includes updating the ranking of feed content based on updated environmental data.

According to an aspect, the feed content comprises media shared through a social media platform. This media may be shared by other users connected to the user or by others on the social media platform.

According to an aspect, the intermediate representation of code comprises byte code, portable code or other object code including instructions for execution on the client device.

According to an aspect, the client comprises a virtual machine or interpreter for processing the intermediate representation of code.

According to an aspect, the intermediate representation of code is downloaded to the client from the server.

According to an aspect, the intermediate representation of code is received by the client via a client-side ranker. The client-side ranker may include an interpreter or other module to process the intermediate representation of code to updating the local ranking algorithm associated with the client side ranker.

According to an aspect, the intermediate representation of code is executable only on the client.

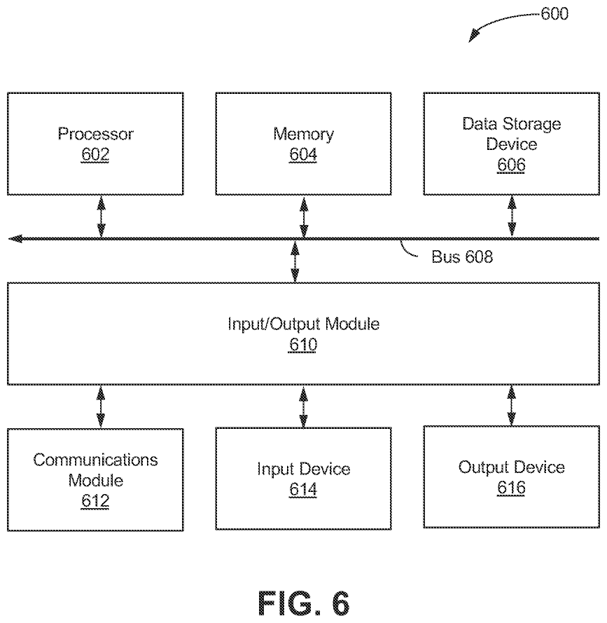

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities.

Computer system 600 (e.g., server and/or client) includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, for displaying information to the user.

According to one aspect of the present disclosure, the above-described gaming systems can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads game data and provides a game, information may be read from the game data and stored in a memory device, such as the memory 604. Additionally, data from the memory 604 servers accessed via a network the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A computer-implemented method for client-side ranking of feed content, comprising:
periodically determining, through communication with a server, a current state of a local ranking algorithm comprising a machine learning (ML) model;
receiving, at a client executing on a device of the user, an intermediate representation of code, the intermediate representation of code being generated based at least in part on the current state of the local ranking algorithm being different from a state of a reference ranking algorithm at the server;
executing, at the client executing on the device of the user, the intermediate representation of code to generate an updated local ranking algorithm;
determining a ranking of feed content for the user based at least in part on the ML model and the updated local ranking algorithm; and
displaying feed content on the device of the user, the feed content displayed according to the ranking.

2. (canceled)

3. The computer-implemented method of claim 1, wherein the local ranking algorithm generates rankings based on at least one of environmental data, social graph data, or user interaction data.

4. The computer-implemented method of claim 3, wherein the user interaction data comprises data regarding at least one of whether the user interacts with media, type of user interaction with media, or dwell time on media.

5. The computer-implemented method of claim 3, wherein the environmental data comprises data regarding at least one of quality of network connection, battery life, location data, inertial sensor data, or date and time data.

6. The computer-implemented method of claim 1, further comprising:
updating the ranking of feed content based on updated user interactions.

7. The computer-implemented method of claim 1, further comprising:
updating the ranking of feed content based on updated environmental data.

8. The computer-implemented method of claim 1, wherein the feed content comprises media shared through a social media platform.

9. The computer-implemented method of claim 1, wherein the intermediate representation of code comprises byte code.

10. The computer-implemented method of claim 1, wherein the client comprises a virtual machine or interpreter.

11. A system configured for client-side ranking of feed content, comprising:
one or more hardware processors configured by machine-readable instructions to:
periodically determine, through communication with a server, a current state of a local ranking algorithm comprising a machine learning (ML) model;
receive, at a client executing on a device of the user, an intermediate representation of code, the intermediate representation of code being generated based at least in part on the current state of the local ranking algorithm being different from a state of a reference ranking algorithm at the server;
execute, at the client, the intermediate representation of code to generate an updated local ranking algorithm;
provide local data to the local ranking algorithm;
determine a ranking of feed content for the user based at least in part on the ML model and the updated local ranking algorithm processing of the local data; and
display feed content on the device of the user, the feed content displayed according to the ranking.

12. (canceled)

13. The system of claim 11, wherein the local data includes on at least one of environmental data, social graph data, or user interaction data.

14. The system of claim 13, wherein the user interaction data comprises data regarding at least one of whether the user interacts with media, type of user interaction with media, or dwell time on media.

15. The system of claim 13, wherein the environmental data comprises data regarding at least one of quality of network connection, battery life, location data, inertial sensor data, or date and time data.

16. The system of claim 11, wherein the one or more hardware processors are further configured by machine-readable instructions to:
update the ranking of feed content based on updated user interactions.

17. The system of claim 11, wherein the one or more hardware processors are further configured by machine-readable instructions to:
update the ranking of feed content based on updated environmental data.

18. The system of claim 11, wherein the local data is provided to the local ranking algorithm in real time.

19. The system of claim 11, wherein the intermediate representation of code comprises bytecode, and wherein the client comprises a virtual machine or interpreter to process the bytecode.

20. A non-transient computer-readable storage medium having instructions embodied thereon, the instructions being executable by one or more processors to perform a computer-implemented method for client-side ranking of feed content, the method comprising:
periodically determining, through communication with a server, a current state of a local ranking algorithm comprising a machine learning (ML) model;
receiving, at a client executing on a device of the user, an intermediate representation of code, the intermediate representation of code being generated based at least in part on the current state of the local ranking algorithm being different from a state of a reference ranking algorithm at the server;
executing, at the client, the intermediate representation of code to generate an updated local ranking algorithm;
receiving, at the client, preliminary ranking data from the server;
obtaining, at the client, local data to provide to the local ranking algorithm;
determining, by the ML model and the updated local ranking algorithm, a ranking of feed content for the user based at least in part on the local data and the preliminary ranking data; and
displaying feed content on the device of the user, the feed content displayed according to the ranking.

21. The computer-implemented method of claim 1, wherein the local ranking algorithm includes applying weight to local data received at least in part in real-time based on a type of the local data.

22. The system of claim 11, wherein the local ranking algorithm includes applying weight to the local data received at least in part in real-time based on a type of the local data.
